(19) United States
(12) Patent Application Publication
(10) Pub. No.: US 2005/0232561 A1
(43) Pub. Date: Oct. 20, 2005

(54) Porous plastic optical transmission article and method for its production

(75) Inventors: Hidenobu Murofushi, Kanagawa (JP); Yuji Watanabe, Kanagawa (JP); Chikafumi Tanaka, Kanagawa (JP); Takaaki Ishigure, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: ASAHI GLASS COMPANY, LIMITED, Tokyo (JP)

(21) Appl. No.: 11/062,479

(22) Filed: Feb. 22, 2005

Related U.S. Application Data
(63) Continuation of application No. PCT/JP03/10589, filed on Aug. 21, 2003.

(30) Foreign Application Priority Data
Aug. 22, 2002 (JP) 2002-242115

(51) Int. Cl. G02B 6/20

(52) U.S. Cl. 385/125

(57) ABSTRACT

To provide a novel porous plastic optical transmission article which is easy to produce and excellent in heat resistance, flame retardancy, chemical resistance and solvent resistance and exhibits a low attenuation and a high bandwidth, and a process for its production. A porous plastic optical transmission article which is an optical transmission article made of an amorphous fluoropolymer containing substantially no C—H bond and which has a plurality of pores at least in a hollow tubular portion provided so as to surround the axial core portion of the optical transmission article. For example, an optical fiber, etc.

### BACKGROUND OF THE INVENTION

1. Field of the Invention

The present invention relates to an optical transmission article to be used, for example, as an optical fiber, particularly to a novel porous plastic optical transmission article which is excellent in heat resistance, flame retardancy, chemical resistance and solvent resistance and which exhibits a low attenuation and a high bandwidth, and a method for its production.

2. Discussion of Background

Optical fiber has excellent characteristics as an optical transmission medium, and heretofore, optical fiber made of an inorganic glass material having an excellent optical transmission property over a particularly wide wavelength, has been used. Further, practical application of an optical fiber (optical fiber strand) made of a plastic material having flexibility in moldability and mechanical characteristics as opposed to a hard and brittle inorganic glass type material, is earnestly being studied.

Heretofore, as optical fiber, a stepped refractive index type optical fiber is common wherein a high refractive index core material is enclosed with a clad (sheath) material having a lower refractive index to form a core/clad structure by the combination of materials having different refractive indices. Many plastic optical fibers of such a structure have been proposed, and some have been practically employed. Specifically, one is known wherein a polymer having good light transmittance such as a polymethyl methacrylate, a polycarbonate or a polystyrene is used as the core base material, and a substantially transparent fluoropolymer having a refractive index smaller than the core basic material, is, for example, used as a clad base material. Further, a plastic optical fiber is also proposed wherein the material for each of the core and the clad is a fluororesin (JP-A-2-244007).

Further, as well as the above-mentioned stepped refractive index type core/clad structure, a refractive index distribution type (GI type) optical fiber is also known wherein the refractive index is exponentially attenuated by having the material distributed in a radial direction from the axial core to the circumferential direction (e.g. “Chemistry and Industry”, Vol. 45, No. 7, 1261-1264 (1992), JP-A-5-173026, WO94/04949, WO94/15005, etc).

Further, an optical fiber (holey fiber) having a structure containing pores, is also known. For example, an optical fiber having air incorporated in a single material of silica glass, is known as a total reflection waveguide type holey fiber wherein light is wave-guided by total reflection by the presence of pores having a low refractive index.

In recent years, attention has been drawn to a photonic crystal fiber wherein such pores extending in parallel with each other in a long axis direction, are periodically arranged to constitute a photonic crystal structure. One of photonic crystal fibers is a total reflection type holey fiber which has a core/clad structure, wherein pores are present in the clad so that the effective refractive index of the clad is lower than the refractive index of the core portion, and light is wave-guided by total reflection.

Further, among photonic crystal fibers, as one showing particularly large wavelength distribution, attention has been drawn to a waveguide principle wherein the core portion constitutes a defect in the periodical arrangement of pores constituting such a photonic crystal structure, and the photonic crystal fiber exhibits a photonic band gap (PBG) against the frequency of light wave-guided through the core portion.

With a fiber utilizing such PBG as the waveguide principle, light having the frequency and transmission constant belonging to PBG will be exponentially attenuated in the clad and can not have a large amplitude, but can have a large amplitude in the core having a defect in the periodicity, whereby the light will be localized at the core. With such PBG fiber, the core may have a hollow structure so long as the periodicity of pores be ruptured, and it is substantially different in this respect from the conventional high refractive index core structure.

A photonic crystal fiber is capable of accomplishing a broad band single mode operation depending upon the size, number and arrangement of pores.

As a holey fiber including such a photonic crystal fiber, a quartz fiber is known, and as its production method, a method (1) is available wherein a columnar body composed mainly of SiO₂ is prepared, then many slender holes extending through in the long axis direction around the axial core portion of the columnar body are formed to prepare a preform having a solid-core structure, and such a preform is stretched (drawn) in the long axis direction to reduce the pore size thereby to obtain an optical fiber.

Further, a method (2) has also been proposed in which many SiO₂ capillaries are bundled in the most densely packed state, and the outer surfaces of capillaries adjacent to one another are fused and integrated to obtain a preform, and such a preform is drawn to produce a photonic crystal fiber (JP-A-2002-97034).

However, an inorganic material is hard and brittle and is essentially poor in processability, and further, an inorganic glass type optical fiber is susceptible to breakage and expensive. Especially, a photonic crystal fiber having a structure in which a plurality of fine pores are periodically arranged in a fine diameter columnar body as mentioned above, is difficult to produce directly, and usually, it is produced by drawing a preform having a cross section similar to the final product, but from an inorganic glass material, even preparation of such a preform is not easy.

For example, by the above method (1), if many slender holes are formed in a columnar body composed mainly of SiO₂, the wall partitioning adjacent slender holes is extremely thin and is likely to break during the processing, and thus preparation of the preform is extremely difficult. Further, by the above method (2), the slender capillaries to be used for fusion and integration are difficult to handle and difficult to maintain the cleanness, whereby not only the attenuation of the final product is likely to be increased, but also it is extremely difficult to fuse and integrate many SiO₂ capillaries bundled in the most densely packed state while maintaining such a form.

### SUMMARY OF THE INVENTION

In the present invention, the above problem is solved by using a specific plastic material having flexibility in moldability and mechanical characteristics as opposed to a hard and brittle material such as SiO₂, in the production of a structure having a plurality of pores. Namely, if an amorphous fluoropolymer containing substantially no C—H bond, is used, even if the desired final product is an optical transmission article of a fine structure having a plurality of pores, its preform can easily be prepared, and further, the drawing processing of the preform will also be easy.

Further, a porous plastic optical fiber employing PMMA has already been proposed and is known to be prepared by e.g. the above method (2). However, a porous plastic optical fiber made of an amorphous fluoropolymer containing substantially no C—H bond has not been known. Further, by using the fluoropolymer, harmonic absorption due to stretching vibration of C—H bond will not take place, thus leading to a remarkable effect such that as compared with an organic polymer such as PMMA, it is possible to obtain an optical transmission article capable of optical transmission in a near infrared region.

Thus, the present invention provides a porous plastic optical transmission article which is made of an amorphous fluoropolymer containing substantially no C—H bond and has a plurality of pores at least in a hollow tubular portion provided so as to surround the axial core portion of the optical transmission article.

In the present invention, the amorphous fluoropolymer containing substantially no C—H bond (hereinafter sometimes referred to simply as the fluoropolymer) is preferably one having a fluorinated cyclic structure, more preferably a fluoropolymer having such a fluorinated cyclic structure in its main chain.

As a preferred fluorinated cyclic structure, a fluorinated alicyclic structure which may contain a cyclic member ether bond, may be mentioned.

The following embodiments may be mentioned as specific structural examples of the present invention.

1) The porous plastic optical transmission article, wherein the plurality of pores are present randomly over the entirety of the optical transmission article including the axial core portion.

2) The porous plastic optical transmission article, wherein the plurality of pores extend in parallel with the long axis direction of the optical transmission article made of the fluoropolymer and are periodically arranged including the axial core portion in the diametrical cross section of the optical transmission article, to form a photonic crystal structure.

3) The porous plastic optical transmission article according to the above 1) or 2), which has a solid-core structure wherein no pores are present at the axial core portion.

4) The porous plastic optical transmission article according to the above 2), wherein the axial core portion has a solid-core structure or a hollow structure, which ruptures the periodicity in arrangement of the pores, and the axial core portion constitutes a defect in the photonic crystal structure.

5) The porous plastic optical transmission article according to the above 4), wherein the photonic crystal structure develops a photonic band gap to the frequency of light wave-guided through the hollow or solid-core axial core portion.

In the present invention, it is also possible to provide a preform to be used for producing the porous plastic optical transmission article, which is made of an amorphous fluoropolymer containing substantially no C—H bond and contains at least a porous hollow molded product having in the tube wall a plurality of pores. Preferably, it is a preform whereby, after stretching, a stretched molded product (the optical transmission article) having a homologous diametrical cross section, can be obtained.

With respect to the method for producing the porous plastic optical transmission article, some examples will specifically be presented as follows. For example, as a method for producing a molded product (preform) to be subjected to stretching,
A) a method of molding the fluoropolymer by extrusion in contact with a gas, or
B) a method of removing from a product of co-extrusion molding of the fluoropolymer with another substance, said another substance, may be mentioned.

By such a method A) or B), by using a proper mold, it is possible to obtain a molded product having a plurality of pores extending in the long axis direction. Further, as such a molded product, not only a preform, but also a porous plastic optical transmission article may directly be produced.

As a method for producing the porous hollow preform, further C) a method which comprises letting a gaseous or volatile low molecular weight blowing agent act on a hollow tube molded from the fluoropolymer, or foaming and molding the fluoropolymer having the blowing agent preliminarily incorporated, into a hollow tube, may be mentioned. By the above method A) to C), by using a proper mold, it is possible to obtain a molded product having a plurality of pores extending in the long axis direction.

Further, as a method for producing a preform having a plurality of pores extending in the long axis direction,
D) a method which comprises melting and introducing the fluoropolymer into an inside space of a tubular container wherein a plurality of slender components are arranged in parallel with one another, and solidifying it, or introducing a liquid containing at least a monomer for the fluoropolymer into said inside space and polymerizing and solidifying it, to obtain a tubular rod, and removing said slender components from the obtained tubular rod,
E) a method which comprises mechanically forming holes in a tubular solid-core rod made of the fluoropolymer, or
F) a method which comprises bundling a plurality of capilli made of the fluoropolymer, and fusing and integrating them as bundled, may be mentioned.

In the above method D) to F), by using a proper mold, it is possible to obtain an axial core hollow and/or solid-core molded product.

It is also possible to provide a method for producing a porous plastic optical transmission article, which comprises stretching the above preform in the long axis direction.

Further, in a case where the above preform has a hollow tubular structure, while inserting a solid-core rod made of the fluoropolymer into the hollow portion of the preform or after inserting the solid-core rod into the porous hollow preform, stretching is carried out in the long axis direction, to obtain a porous plastic optical transmission article having a solid-core structure.

In the present invention, the above porous plastic optical transmission article is specifically an optical fiber. A bundled fiber having at least two such optical fibers bundled, or a multi-core cable having at least two such optical fibers accommodated in one cable, may also be provided.

Further, in the present invention, as the porous plastic optical transmission article, a light guide, a switch or a rod lens may, for example, be mentioned, and such an article may be obtained by using the above preform.

### BRIEF DESCRIPTION OF THE DRAWINGS

FIG. 1 is a schematic diametric cross section illustrating an embodiment (an entirely random porous structure) of the porous plastic optical transmission article of the present invention.

FIG. 2 is a schematic diametric cross section illustrating an embodiment (an entirely periodic arrangement pore structure) of the porous plastic optical transmission article of the present invention.

FIG. 3 is a schematic diametric cross section illustrating an embodiment (a solid-core/pore periodic arrangement clad layer structure) of the porous plastic optical transmission article of the present invention.

FIG. 4 is a schematic diametric cross section illustrating an embodiment (a separate material solid-core/pore periodic arrangement clad layer structure) of the porous plastic optical transmission article of the present invention.

FIG. 5 is a schematic diametric cross section illustrating an embodiment (a solid-core/pore honeycomb periodic arrangement clad layer structure) of the porous plastic optical transmission article of the present invention.

FIG. 6 is a schematic diametric cross section illustrating an embodiment (a hollow core/pore periodic arrangement clad layer structure) of the porous plastic optical transmission article of the present invention.

FIG. 7 is a schematic diametric cross section of an embodiment wherein the porous plastic optical transmission article of the present invention is a multi-core cable.

FIG. 8 is a cross-sectional view of a fiber prepared in Example 1 of the present invention.

### MEANINGS OF SYMBOLS

1: optical transmission article, 2: hollow tubular layer made of the fluoropolymer, 3: pore, 4: solid-core axial core portion made of a fluoropolymer different from the hollow tubular layer, 5: hollow axial core portion, 6: coating layer, 7: cable

### DETAILED DESCRIPTION OF THE PREFERRED EMBODIMENTS

Now, the present invention will be described in detail.

In the present invention, the optical transmission article may specifically be, for example, an optical fiber, a light guide, a switch or a rod lens.

The porous plastic optical transmission article of the present invention is a novel optical transmission article having the porous structure formed by using a specific molding material which will be described hereinafter and is characterized in that it has a porous structure having a plurality of pores at least in a hollow tubular portion provided so as to surround the axial core portion of the optical transmission article.

With respect to the optical transmission article of the present invention, so long as it has the above porous structure, the optical waveguide principle may, for example, be a total reflection type, a stepped refractive index type or one utilizing PBG as the waveguide principle, and is not particularly limited.

Further, the number, shape or arrangement of pores, the axial core portion structure of the optical transmission article, the size of the axial core portion, the size of the optical transmission article, such as the diameter of the optical fiber, etc., are also not particularly limited and may suitably be designed depending upon the purpose of the optical transmission article. Further, in a case where the axial core portion has a solid-core structure, it may be formed of the same fluoropolymer as in the porous hollow tubular layer, or may be formed of a fluoropolymer different therefrom. Further, in a case where the axial core portion has a hollow structure, the cross-sectional shape of the pore may suitably be selected, such as a circular or polygonal shape.

For example, the structure of the axial core portion of the optical transmission article of the present invention may be such that by the arrangement of the plurality of pores, the hollow structure of the hollow tubular portion will be determined, and it may form a solid-core/clad structure having such hollow portion filled, otherwise at such hollow portion, the same porous structure as for the hollow tubular portion may be formed, or the hollow portion may be left as it is. As specific examples, those described above as embodiments 1) to 5) may be mentioned. Now, they will be described with reference to the diametric cross-sectional views illustrating some embodiments.

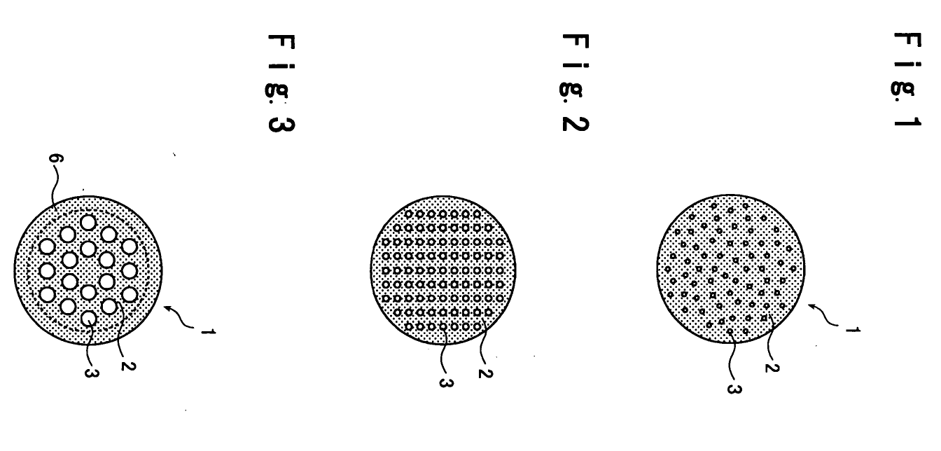

1) The porous plastic optical transmission article, wherein the plurality of pores are present randomly over the entirety of the optical transmission article including the axial core portion. FIG. 1 shows a total reflection type holey fiber wherein pores 3 are randomly present over the entire optical transmission article 1 made of the fluoropolymer 2.

2) The porous plastic optical transmission article, wherein the plurality of pores extend in parallel with the long axis of the optical transmission article made of the fluoropolymer and are periodically arranged including the axial core portion in the diametrical cross section of the optical transmission article, to form a photonic crystal structure.

FIG. 2 shows a total reflection type holey fiber having a structure in which a plurality of pores 3 are periodically arranged over the entire optical transmission article 1.

3) The porous plastic optical transmission article according to the above 1) or 2), which has a solid-core structure wherein the pores at the axial core portion are filled with the above fluoropolymer.

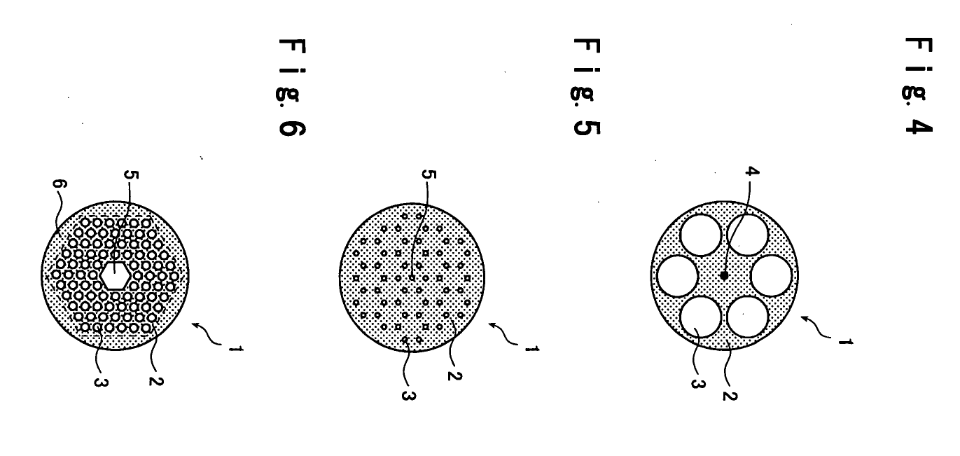

FIG. 3 and FIG. 4 show total reflection type holey fibers having a clad layer structure with solid-core/pore periodic arrangement. FIG. 3 shows an embodiment wherein the hollow tubular layer has a plurality of pores 3 periodically arranged to surround the center core portion, and the axial core portion is made solid-core with the same fluoropolymer 2 as in the hollow tubular layer, and FIG. 4 is an embodiment wherein the axial core portion is made solid-core with a fluoropolymer 4 different from one in the hollow tubular layer.

4) The porous plastic optical transmission article according the above 2), wherein the axial core portion has a solid-core structure or a hollow structure, which ruptures the periodicity in arrangement of the pores, and the axial core portion constitutes a defect in the photonic crystal structure.

5) The porous plastic optical transmission article according the above 4), wherein the photonic crystal structure develops a photonic band gap (PBG) to the frequency of light wave-guided through the hollow or solid-core axial core portion.

Embodiments utilizing PBG as the waveguide principle, are shown in FIGS. 5 and 6. FIG. 5 shows an embodiment which has a photonic crystal structure wherein a plurality of pores 3 are periodically arranged to form a honeycomb structure and which has a hollow structure (hollow axial core portion 5) which ruptures the above periodicity of pores, at the axial core portion. FIG. 6 has a photonic crystal structure wherein pores 3 are arranged in a hexagonal lattice structure and has a hexagonal pore having a diameter larger than the pore 3, at the axial core portion.

The fluoropolymer constituting the optical transmission article of the present invention is not particularly limited so long as it is an amorphous fluoropolymer having substantially no C—H bond. However, it is preferably one having a fluorinated cyclic structure. The fluorinated cyclic structure may specifically be, for example, a fluorinated alicyclic structure which may contain a cyclic member ether bond (hereinafter sometimes referred to simply as a fluorinated alicyclic structure), a fluorinated imide cyclic structure, a fluorinated triazine cyclic structure or a fluorinated aromatic cyclic structure. Among the above fluorinated cyclic structures, a fluorinated alicyclic structure which may contain a cyclic member ether bond, or a fluorinated polyimide cyclic structure, is preferred, and the former is more preferred.

Further, a fluoropolymer having such a fluorinated cyclic structure in its main chain, is particularly preferred. Further preferred is one which is melt moldable, wherein the main chain-constituting unit containing such a cyclic structure substantially forms a linear structure. Particularly preferred is a fluoropolymer having a fluorinated alicyclic structure in its main chain.

In the following, firstly, a fluoropolymer having a fluorinated alicyclic structure in its main chain will be described in detail as a particularly preferred fluoropolymer.

The fluoropolymer having a fluorinated alicyclic structure in its main chain is a fluoropolymer, of which the main chain is a chain of carbon atoms and which has a fluorinated alicyclic structure in the main chain.

“Having a fluorinated alicyclic structure in its main chain” means to have a structure wherein at least one carbon atom constituting the alicyclic ring is the carbon atom in the carbon chain constituting the main chain, and a fluorine atom or a fluorine-containing group is bonded to at least part of carbon atoms constituting the alicyclic ring.

The hollowing structures may, for example, be mentioned as a constituting unit of the main chain having a fluorinated alicyclic structure as a preferred embodiment of the fluoropolymer in the present invention.

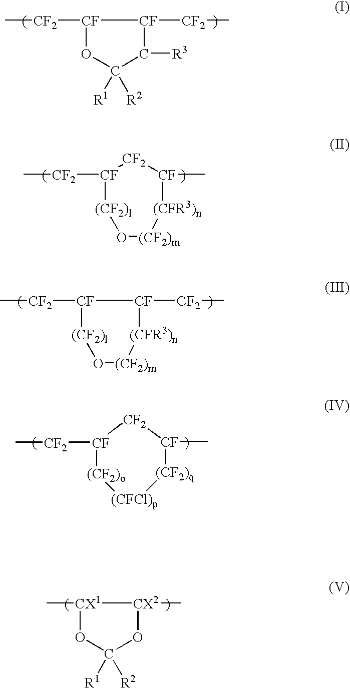

In the above formulae, 1 is from 0 to 5, m is from 0 to 4, n is from 0 to 1, l+m+n is from 1 to 6, each of o, p and q which are independent of one another, is from 0 to 5, o+p+q is from 1 to 6, each of R¹, R² and R³ which are independent of one another, is F, Cl, CF₃, C₂F₅, C₃F₇ or OCF₃, and each of X¹ and X² which are independent of each other, is F, Cl or CF₃.

As the polymer having a fluorinated alicyclic structure, preferred is specifically \mathring{1} a polymer obtained by polymerizing a monomer having a fluorinated alicyclic structure (a monomer having a polymerizable double bond between a carbon atom constituting the ring and a carbon atom not constituting the ring, or a monomer having a polymerizable double bond between two carbon atoms constituting the ring), or \mathring{2} a polymer having a fluorinated alicyclic structure in its main chain, obtained by cyclopolymerization of a fluorinated monomer having at least two polymerizable double bonds.

The above monomer having a fluorinated alicyclic structure is preferably a monomer having one polymerizable double bond, and the above cyclopolymerizable fluorinated monomer is preferably a monomer having two polymerizable double bonds and having no fluorinated alicyclic structure.

Here, a copolymerizable monomer other than a fluorinated monomer cyclopolymerizable with a monomer having a fluorinated alicyclic structure will hereinafter be referred to as “another radical polymerizable monomer”.

The carbon atoms constituting the main chain of the fluoropolymer are constituted by the two carbon atoms of the polymerizable double bond of the monomer. Accordingly, with a monomer having a fluorinated alicyclic structure having one polymerizable double bond, one or each carbon atom of the two carbon atoms constituting the polymerizable double bond will be the atom constituting the alicyclic ring. With the fluorinated monomer having no alicyclic ring and having two polymerizable double bonds, one carbon atom of one polymerizable double bond and one carbon atom of the other polymerizable double bond will be bonded to form a ring. An alicyclic ring will be formed by the bonded two carbon atoms and atoms present between them (excluding atoms in a side chain), and in a case where an etheric oxygen atom is present between the two polymerizable double bonds, a fluorinated aliphatic ether cyclic structure will be formed.

The polymer having a fluorinated alicyclic structure in its main chain obtained by polymerizing a monomer having a fluorinated alicyclic structure, can be obtained by polymerizing a monomer having a fluorinated alicyclic structure, such as a perfluorodioxol having a fluorine or a fluorinated alkyl group such as a trifluoromethyl group, a pentafluoroethyl group or a heptafluoropropyl group, on a dioxol cyclic member carbon of e.g. perfluoro(2,2-dimethyl-1,3-dioxol) (simply referred to as PDD), perfluoro(2-methyl-1,3-dioxol), perfluoro(2-ethyl-2-propyl-1,3-dioxol) or perfluoro(2,2-dimethyl-4-methyl-1,3-dioxol), perfluoro(4-methyl-2-methylene-1,3-dioxolane) (simply referred to as MMD), or perfluoro(2-methyl-1,4-dioxin).

Further, a polymer having a fluorinated alicyclic structure in its main chain obtained by copolymerizing such a monomer with another radical polymerizable monomer containing no C—H bond, may also be used. If the proportion of the content of polymerized units of another radical polymerizable monomer becomes large, the light transmittance of the fluoropolymer may sometimes decrease. Accordingly, as the fluoropolymer, preferred is a homopolymer of the monomer having a fluorinated alicyclic structure or a copolymer wherein the proportion of the content of polymerized units of such a monomer is at least 70 mol %.

As another radical polymerizable monomer containing no C—H bond, tetrafluoroethylene, chlorotrifluoroethylene or perfluoro(methyl vinyl ether) may, for example, be mentioned.

As a commercially available amorphous fluoropolymer having substantially no C—H bond of this type, the above-mentioned perfluoro-2,2-dimethyl-1,3-dioxol type polymer (Teflon AF, tradename, manufactured by Du Pont), or perfluoro-4-methyl-1,3-dioxol type polymer (HYFLON AD, tradename, manufactured by Ausimont) may, for example, be mentioned.

Further, the polymer having a fluorinated alicyclic structure in its main chain obtained by cyclic polymerization of a fluorinated monomer having at least two polymerizable double bonds, is known, for example, by JP-A-63-238111, JP-A-63-238115, etc. Namely, a polymer having a fluorinated alicyclic structure in its main chain may be obtained by cyclic polymerization of a monomer such as perfluoro(3-oxa-1,5-hexadiene) or perfluoro(3-oxa-1,6-heptadiene) (simply referred to as PBVE), or by copolymerizing such a monomer with another radical polymerization monomer containing no C—H bond, such as tetrafluoroethylene, chlorotrifluoroethylene or perfluoro(methyl vinyl ether). By the above cyclic polymerization of PBVE, a polymerized unit having a 5-membered cyclic ether structure in its main chain, as shown in the above formula (1) will be formed by bonding of carbons at 2,6-positions.

Further, as the fluorinated monomer having at least two polymerizable double bonds, in addition to those mentioned above, a monomer having a substituent on a saturated carbon of PBVE may, for example, be preferred. Specifically, perfluoro(4-methyl-3-oxa-1,6-heptadiene) (simply referred to as PBVE-4M), perfluoro(4-chloro-3-oxa-1,6-heptadiene) (simply referred to as PBVE-4Cl), perfluoro(5-methoxy-3-oxa-1,6-heptadiene) (simply referred to as PBVE-5MO) or perfluoro(5-methyl-3-oxa-1,6-heptadiene) may, for example, be preferred. If the proportion of polymerized units of another radical polymerizable monomer becomes large, the light transmittance of the fluoropolymer may sometimes decrease. Accordingly, as the fluoropolymer, preferred is a homopolymer of a fluorinated monomer having at least two polymerizable double bonds, or a copolymer wherein the proportion of polymerized units of such a monomer is at least 40 mol %.

As a commercial product of such an amorphous fluoropolymer having substantially no C—H bond, “CYTOP” (manufactured by Asahi Glass Company, Limited) is available.

Further, it is possible to obtain a fluoropolymer having a fluorinated alicyclic structure in its main chain also by copolymerizing a monomer having a fluorinated alicyclic structure such as perfluoro(2,2-dimethyl-1,3-dioxol) with a fluorinated monomer having at least two polymerizable double bonds such as perfluoro(3-oxa-1,5-hexadiene) or perfluoro(3-oxa-1,6-heptadiene) (PBVE). Also in this case, depending upon the combination, there may be a case where the light transmittance decreases. Accordingly, preferred is a copolymer wherein the proportion of polymerized units of a fluorinated monomer having at least two polymerizable double bonds, is at least 30 mol %.

The polymer having a fluorinated alicyclic structure is preferably a polymer having the cyclic structure in its main chain. However, one containing at least 20 mol %, preferably at least 40 mol %, of polymerized units having a cyclic structure, based on the total polymerized units, is preferred from the viewpoint of the transparency, mechanical properties, etc.

Further, the polymer having a fluorinated alicyclic structure is preferably a perfluoropolymer. Namely, preferred is a polymer wherein all hydrogen atoms bonded to carbon atoms are substituted by fluorine atoms.

However, a part of fluorine atoms of the perfluoropolymer may be substituted by atoms other than hydrogen atoms, such as chlorine atoms or heavy hydrogen atoms. Presence of chlorine atoms brings about an effect to increase the refractive index of the polymer, and accordingly, a polymer having chlorine atoms is particularly useful as the fluoropolymer.

The above fluoropolymer preferably has a sufficiently high molecular weight so that the optical transmission article has heat resistance, it is hardly softened even when exposed at a high temperature, and the light transmission performance will not decrease. Further, the molecular weight of the fluoropolymer to provide such characteristics has a melt moldable level of the molecular weight as its upper limit. However, when it is represented by an intrinsic viscosity [η] measured in perfluoro(2-butyltetrahydrofuran) (PBTHF) at 30° C., it is usually preferably at a level of from 0.1 to 1 dl/g, more preferably at a level of from 0.2 to 0.5 dl/g. Here, the number average molecular weight corresponding to the intrinsic viscosity is usually at a level of from 1×10⁴ to 5×10⁶, preferably at a level of from 5×10⁴ to 1×10⁶.

Further, in order to secure the processability during the melt spinning of the above fluoropolymer or during the stretching of the preform, the melt viscosity of the fluoropolymer when the fluoropolymer is melted at a temperature of from 200 to 300° C., is preferably at a level of from 1×10² to 1×10⁵ Pa·s.

The fluoropolymer having the above-described fluorinated alicyclic structure is particularly preferred for such a reason that as compared with a fluoropolymer having the after-mentioned fluorinated imide cyclic structure, fluorinated triazine cyclic structure or fluorinated aromatic cyclic structure, even if formed into a fiber by melt spinning or heat stretching, the polymer molecules can hardly be aligned, whereby light scattering hardly takes place. Especially preferred is a fluoropolymer having a fluorinated aliphatic ether cyclic structure.

The above-mentioned fluoropolymer having a fluorinated alicyclic structure in its main chain is a preferred fluoropolymer of the present invention. However, as mentioned above, the fluoropolymer of the present invention is not limited thereto.

For example, it is possible to use an amorphous fluoropolymer having a fluorinated cyclic structure other than the fluorinated alicyclic structure in its main chain, having substantially no C—H bond, as disclosed in JP-A-8-5848. Specifically, it is possible to use an amorphous fluoropolymer having a fluorinated cyclic structure such as a fluorinated imide cyclic structure, fluorinated triazine cyclic structure or fluorinated aromatic cyclic structure, in its main chain. The melt viscosity or the molecular weight of such a polymer is preferably within the same range as the one of the above-mentioned fluoropolymer having a fluorinated alicyclic structure in its main chain.

As the fluoropolymer having a fluorinated imide cyclic structure in its main chain, as a preferred fluoropolymer of the present invention, ones having repeating units represented by the following formulae may specifically be exemplified. 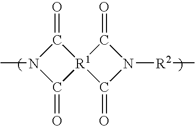
(in the above formula, R¹ is selected from the following: 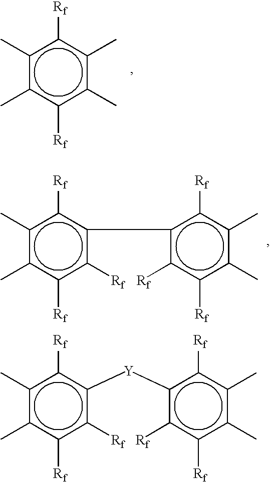
R² is selected from the following:

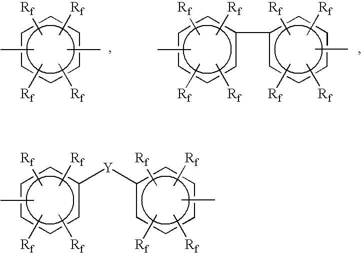

Here, R^{f} is selected from a fluorine atom, a perfluoroalkyl group, a perfluoroaryl group, a perfluoroalkoxy group and a perfluorophenoxy group, and they may be the same or different. Y is selected from the following:
—O—, —CO—, —SO₂—, —S—, —R′_{f}—,
[symbol] OR′_{f} [symbol] ᵣ, [symbol] R′ᵣO [symbol] ᵣ, [symbol] OR′_{f}O [symbol] ᵣ,
[symbol] SR′_{f} [symbol] ᵣ, [symbol] R′_{f}S [symbol] ᵣ, [symbol] SR′_{f}S [symbol] ᵣ,
[symbol] SR′_{f}O [symbol] ᵣ, [symbol] OR′_{f}S [symbol] ᵣ

Here, R′_{f} is selected from a perfluoroalkylene group, and a perfluoroarylene group, and they may be the same or different. r is from 1 to 10. Y and two R_{f} may form a ring together with carbon, and in such a case, the ring may be a saturated ring or an unsaturated ring.)

Further, in the present invention, the fluoropolymer having a fluorinated aromatic cyclic structure may be a fluorinated product of a polymer having an aromatic ring in a side chain or in the main chain of e.g. polystyrene, polycarbonate or polyester. Such a product may be a perfluoropolymer having entirely fluorinated or may be one having a fluorinated residue substituted by chlorine. Further, it may have e.g. a trifluoromethane substituent.

Further, fluorine atoms in the fluoropolymer may partially be substituted by chlorine atoms in order to increase the refractive index. Further, a substance to increase a refractive index may be incorporated to the fluoropolymer of the present invention, but it is important that the molding material of the present invention contains substantially no C—H bond as a whole.

In the foregoing, the fluoropolymer constituting the optical transmission article has been described. However, in the present invention, the above polymer as preliminarily polymerized, may be used as the molding material, or a polymerizable monomer capable of forming the above fluoropolymer may be used and polymerized at the time of molding.

In the present invention, the production method is not particularly limited so long as a porous plastic optical transmission article of the present invention can be obtained by molding the above fluoropolymer into the above specific structure. However, it is preferred to stretch a preform having the porous structure preliminarily formed, in the long axis direction (hereinafter, stretching means stretching in the long axis direction and has the same meaning as drawing), whereby the production is easy. Especially, by stretching a preform having a number of holes formed in the long axis direction, the size of holes can be reduced, and a porous optical fiber can easily be obtained. Further, by using the above fluoropolymer, the preform can also be easily formed.

Accordingly, in the present invention, it is possible to provide a preform to be used for producing the porous plastic optical transmission article, which is made of an amorphous fluoropolymer containing substantially no C—H bond and contains at least a porous hollow molded product having a plurality of pores in the tube wall. Preferred is a preform whereby after stretching, a stretched molded product having a homologous diametrical cross section (optical transmission article) can be obtained.

In the present invention, as a method for producing the above porous plastic optical transmission article, the above-mentioned specific examples may be mentioned. For example, if a specific explanation is made mainly with respect to the method for producing the molded product (preform) to be subjected to stretching,
A) a method of molding the fluoropolymer by extrusion in contact with a gas, or
B) a method of removing from a molded product of co-extrusion of the fluoropolymer with another substance, said another substance, may be mentioned.

As a method for producing the porous hollow preform, further C) a method of letting a gaseous or volatile low molecular weight blowing agent act on a hollow tube molded from the fluoropolymer, or foaming and molding the fluoropolymer having such a blowing agent preliminarily incorporated, into a hollow tube, may be mentioned.

Further, as a method for producing a preform having a plurality of pores extending in the long axis direction,
D) a method of melting and introducing the fluoropolymer into an inside space of a tubular container wherein a plurality of slender components are arranged in parallel with one another, and solidifying it, or introducing a liquid containing at least a monomer to obtain the fluoropolymer into said inside space and polymerizing and solidifying it, to obtain a tubular rod, and removing said slender components from the obtained tubular rod,
E) a method of mechanically forming holes in a tubular solid-core rod made of the fluoropolymer, or
F) a method of bundling a plurality of capilli made of the fluoropolymer, and fusing and integrating them as bundled, may be mentioned.

By the above methods A) and B), by using a proper mold, it is possible to obtain a molded product having a plurality of pores extending in the long axis direction. Further, as the molded product, not only a preform, but also a porous plastic optical transmission article may directly be produced.

By the above methods A) to C), by using a proper mold, it is possible to obtain a molded product having a plurality of pores extending in the long axis direction.

By the above methods D) to F), by using a proper mold, it is possible to obtain an axial core hollow and/or solid-core molded product.

In the present invention, even by the method of mechanically forming holes in a tubular solid-core rod by the above method E), there will be no such a problem that the partition portion between adjacent pores will break during the processing.

Further, by stretching the above preform in the long axis direction, it is possible to produce a porous plastic optical transmission article.

At that time, in a case where the above preform has a hollow tubular structure, while inserting a solid-core rod made of a fluoropolymer into the hollow portion of the preform, or after inserting such a solid-core rod into the porous hollow preform, stretching may be carried out in the long axis direction, whereby it is possible to obtain a porous plastic optical transmission article having a solid-core structure.

The production methods A) to E) will be described with reference to more specific examples, including a step of stretching a preform in some cases.

A) Method for Directly Forming Pores

The fluoropolymer is molded by extrusion in contact with air or other gas to form a porous product thereby to obtain a preform or a porous plastic optical fiber.

This is an extrusion method wherein the cross head portion is shaped to dispose nozzles so that many hollow tubes will be formed, and a resin will be filled except for the positions of nozzles, while from the nozzles, a pressure of at least atmospheric pressure is generated by a gas such as air to such an extent that the hollow state can be maintained even after the extrusion. The gas in this case may be any gas such as air, nitrogen, argon or helium, but from the viewpoint of the safety and availability, air or nitrogen is preferred. Further, the pressure may freely be changed depending upon the ejection pressure of the resin under a pressure of at least atmospheric pressure, other than reduced pressure.

B) Formation of Pores by Remoal of Islands

Co-extrusion of the fluoropolymer and at least one other substance is carried out to form a preform or an optical fiber, and then, a step of removing such at least one other substance is carried out.

As such at least one other substance, a resin such as PMMA, rubber, a paste having a readily soluble solid such as a carbonate dispersed, or a liquid such as a high boiling point solvent, may be mentioned. Among them, a liquid is preferred from the viewpoint of removal after the extrusion. Further, from the viewpoint of control of the extrusion pressure, a resin is preferred.

The result of such co-extrusion may be in the form of a preform or may be in the fine diameter state like a fiber directly formed. However, from the viewpoint of the efficiency for removal, a method of once preparing a preform, carrying out the removal at that stage and then spinning and stretching the preform, is more efficient.

Further, said at least one other substance may be removed by dissolution or decomposition to form hollow portions, by treating it with at least one substance selected from the group consisting of an organic solvent, water, an acid and an alkaline solution.

As the manner for removal, said at least one other substance may be treated with at least one substance selected from the group consisting of an organic solvent, water, an acid and an alkaline solution thereby to remove it by dissolution or decomposition. From the viewpoint of the handling efficiency, for example, in a case where PMMA is used, it can easily be dissolved and removed by an organic solvent such as acetone. The preform may be immersed in the solvent, and if ultrasonic wave is applied at that time, the dissolution speed will be increased. After the removal, the preform may be vacuum dried and usually drawn to obtain an optical fiber.

This method is a method wherein the high chemical resistance of a fluororesin i.e. the characteristic of a fluororesin such that it undergoes no change by e.g. a strong acid, a strong alkali and many organic solvents, is utilized to the maximum extent.

C) Foaming Method

A hollow tube is preliminarily prepared from the fluororesin, then impregnated with a gaseous or volatile low molecular weight blowing agent, followed by foaming at a temperature of at least the glass transition temperature to prepare a porous hollow tube, or a resin which is preliminarily impregnated with a gaseous or volatile low molecular weight blowing agent, is foamed in the process of molding into a hollow tube, to obtain the hollow tube, then the porous hollow tube and a solid-core rod not containing the above gas or volatile component at the center, are simultaneously stretched, or the two are joined in the form of a rod-in-tube to prepare an integrated preform, followed by stretching.

Further, the periphery of the porous hollow tube may further be covered with at least one layer of a hollow tube not containing the gas, or may be so covered and stretched.

The method for preparing such a hollow tube is not particularly limited and may, for example, be a method of introducing a molten resin into a double layered concentric cylinder, followed by cooling for solidification, a method of introducing a monomer and a polymerization initiator into such a cylinder, followed by polymerization and solidification, or a method for preparing a hollow tube by centrifugal force by horizontal rotational molding as in JP-A-8-334633, and thus various methods are possible. By exposing the hollow tube thus prepared, to the atmospheric air, the air will be absorbed in the resin, and when heated again to the melting temperature, foaming takes place. The size and amount of foams formed by this foaming can be adjusted by the temperature and the time. Otherwise, a resin having air or the like absorbed therein, may be melted, and in a state where foaming is being taken place, such a hollow tube may be prepared.

The porous hollow tube thus prepared and a solid-core rod not foamed having an outer diameter smaller than the inner diameter of the hollow tube, may be combined to obtain a preform, followed by stretching, or they may simultaneously be drawn, to form a photonic crystal fiber which has a solid-core at the center and a porous resin disposed outside thereof to serve as a clad. The diametric ratio of the core and the clad will be determined by the initial combination of the hollow tube and the solid-core rod.

At that time, it is more preferred from the viewpoint of the strength of the fiber that a preform is prepared by combining a hollow tube not foamed, on the outside of the foamed hollow tube, or to combine it at the time of drawing thereby to provide a second clad layer.

D) Templating Method

\mathring{1} A cylindrical container and a plurality of slender components spatially arranged in the container in a prescribed manner,

\mathring{2} in the space, a molten resin is introduced, and then cooled and solidified, or a liquid containing at least a monomer is introduced, and polymerized and solidified,

\mathring{3} from the solidified resin, the above-mentioned slender components are removed, to form a preform having pores extending in the long axis direction, and

\mathring{4} the preform is stretched.

As the above slender components, glass, metal or plastic may, for example, be employed.

The material of the cylindrical container to be used above is not particularly limited. For example, it may be a metal tube, a glass tube or one made of a resin such as a PFA tube. The preform can be taken out from the cylinder by extrusion, and in a case where it is made of a resin, it is also possible to peel it by a knife or the like. Further, the diameter may be selected to be of an optional size depending upon the preform desired to be produced.

The slender components may be rods including tubes, or rod-shaped ones, and they are typically glass rods, steel rods or resin rods. They are maintained to have a desired spatial arrangement, for example, by a holding means (such as a bottom end cap and an upper end cap provided with optionally arranged holes and recesses).

Further, the slender components are physically, chemically or thermally movable slender components, such as polymer rods or fibers. The slender components may not necessarily have a circular cross section, or may not necessarily all have the same size or the same shape.

The slender components will be removed after solidification of the resin, but the method for the removal is not limited. They may be physically withdrawn or chemically dissolved or decomposed. For example, in the case of glass, it may be dissolved by hydrofluoric acid, and in the case of a metal, it may readily be dissolved by an acid such as hydrochloric acid or nitric acid. Further, in a case where a resin such as PMMA is employed, it can easily be removed by an organic solvent such as acetone. In either case, with respect to dissolution, hollow tubes can easily be removed from the viewpoint of the contact area. Further, in a case where the inner wall after the withdrawal is not smooth, the preform may be immersed in a solvent such as C₈F₁₈ in a short time, whereby the surface will be etched, and a smooth inner surface may be obtained, such being effective with a view to reducing the attenuation.

E) In a columnar resin, holes are mechanically formed so that the regularity is collapsed only at the center portion, and the inner walls of the holes are subjected to etching and made smooth with a solvent which is capable of dissolving the resin.

In the case of quartz or glass, this method used to have a drawback that it is susceptible to breakage during the molding or after the molding. However, in the case of a resin, no such a problem will result.

As means to form holes, various means such as drilling, superhigh pressure water and lasers, are possible. However, the inner surfaces of holes thus formed are not optically smooth, and taking advantage of such a characteristic that the amorphous fluororesin is soluble in a perfluoro solvent, the preform may be immersed in a solvent such as C₈F₁₈ in a short time, whereby the surfaces will be etched, and smooth inner surfaces can be obtained.

F) The method of bundling a plurality of capillaries made of the fluoropolymer and fusing and integrating them as bundled, may be carried out by using the fluoropolymer of the present invention in accordance with the method disclosed in e.g. JP-A-2002-97034. Here, the method disclosed in this publication is hereby included in this specification by reference.

The above-described methods of the present invention are not restricted to the above description. On the other hand, for example, in a case where a porous plastic optical fiber is produced by means of an acrylic resin such as PMMA or a hydrocarbon polymer such as a polycarbonate, they may be widely applied by replacing such a polymer with a resin other than the fluororesin according to the present invention, and further, they may be applied likewise to an elastomer such as rubber.

The above methods of the present invention have several merits over conventional methods for producing optical fibers having fine structures. For example, the methods of the present invention can produce relatively large preforms in a large amount. Further, while using raw materials more inexpensive than conventional processes for optical fibers, preforms having high purity can be obtained. Further, the degree of freeness in the arrangement of hollow portions is high.

The porous plastic optical transmission article of the present invention may have one or more coating layers containing no pores on the periphery of the hollow tubular layer having a plurality of pores.

In the present invention, the porous plastic optical transmission article is specifically an optical fiber.

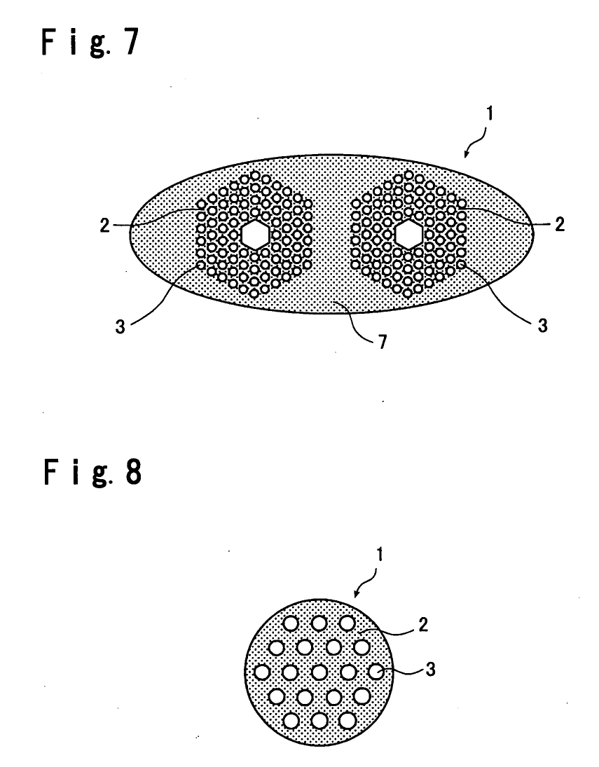

A bundled fiber having at least two such optical fibers bundled, and further a multi-core cable having at least two optical fibers accommodated in one cable, are also provided. An embodiment of such a multi-core cable is shown in FIG. 7. This embodiment is an embodiment wherein two fibers containing no covering layer 6 as shown in FIG. 6, are accommodated in a cable 7, wherein the same symbols as in FIG. 6 represent the same or corresponding portions, and therefore their description will be omitted here.

In the present invention, if the fluoropolymer of the present invention such as the hollow tubular layer material 2, is used as the material for the cable 7, the above multi-core cable can easily be produced.

Further, in the present invention, the porous plastic optical transmission article may, for example, be a light guide, a switch or a rod lens, and such an article can be obtained by applying the above-described preform.

### EXAMPLES

Now, the present invention will be described in further detail with reference to Examples, but it should be understood that the present invention is by no means restricted to such Examples.

### Example 1

By an extruder provided with a cross head having nineteen nozzles, a perfluoro(3-oxa-1,6-heptadiene) polymer (PBVE polymer) was extruded at 250° C. while blowing air under 0.2 MPa from the nozzles to obtain a fiber having a diameter of 500 μm. The cross section of this fiber is shown in FIG. 8. The diameter of each pore is about 10 μm.

The attenuation of the obtained fiber was measured and found to be 50 dB/km at 850 nm, and the bandwidth at 200 m was 10 GHz.

### Example 2

By an extruder provided with a porous die, a PBVE polymer and PMMA were co-extruded at 230° C. so that the PBVE polymer constituted a sea structure, while PMMA constituted island structures. A preform having a diameter of 10 mm and a length of 200 mm was obtained. This preform was immersed in a test tube made of glass and filled with acetone, and subjected to ultrasonic cleaning together with the glass tube to carry out dissolution for 20 hours. After dissolving PMMA, cleaning with acetone was again carried out for 10 minutes, followed by vacuum drying at 60° C. for 40 hours.

The island structures became pores by dissolution of PMMA, and a preform having 30 pores having diameters of about 1 mm extending in the long axis direction randomly formed, was stretched at 240° C. by means of a drawing furnace to obtain a fiber having a diameter of 300 μm. The cross section of the obtained fiber was analogous to the preform before stretching. The attenuation of this fiber was measured and found to be 50 dB/km at 850 nm, and the bandwidth at 200 m was 10 GHz.

### Example 3

By an extruder provided with a porous die, a PBVE polymer and a paste having a powder of sodium carbonate dispersed in an oil, were co-extruded at 230° C. so that the PBVE polymer constituted a sea structure and the paste constituted island structures, thereby to obtain a preform having a diameter of 10 mm and a length of 250 mm. This preform was immersed in a test tube made of glass and filled with ultrapure water and subjected to ultrasonic cleaning for 5 hours together with the glass tube to dissolve the paste. Thereafter, cleaning was carried out again with ultrapure water for 10 minutes, followed by vacuum drying at 60° C. for 40 hours.

A preform having a plurality of pores extending in the long axis direction formed by dissolution of the paste, was stretched at 240° C. by means of a drawing furnace, to obtain a fiber having a diameter of 500 μm. The cross section of the obtained fiber was analogous to the preform. The attenuation of this fiber was measured and found to be 50 dB/km at 850 nm, and the bandwidth at 200 m was 10 GHz.

### Example 4

### Preparation of Preform

A resin (PBVE polymer) was packed into a PFA tube having an inner diameter of 20 mm, and PFA stoppers were placed at the top and bottom. The tube was held in an evacuated metal tube and then, it was placed horizontally in an oven and rotated at 250° C. for 2,000 rpm to obtain a hollow tube having an outer diameter of 20 mm and an inner diameter of 5 mm.

The obtained hollow tube was removed from the PFA tube and left to stand in air for 40 hours. Thereafter, this hollow tube was again held at 200° C. for 10 minutes, to obtain a foamed hollow tube (a porous hollow preform 2) which had no substantial change on appearance but had foams of a size of about 0.5 mm uniformly distributed in the interior.

By rotational molding in the same manner as above, a non-foamed hollow tube (cover preform 3) having an outer diameter of 40 mm and an inner diameter of 22 mm was molded.

The above resin was melted and introduced into a PFA tube having an inner diameter of 5 mm to obtain a solid-core rod (core preform 1).

The three preforms thus produced were cocentrically placed in the order of the solid-core rod 1, the foamed hollow tube 2 and the non-foamed hollow tube 3, followed by stretching at 240° C. in a drawing furnace to obtain a fiber having a diameter of 500 μm.

The cross section of the obtained fiber was analogous to the preform, and a porous fiber was obtained which comprised a solid-core at the center, a hollow tubular layer having many pores extending in the long axis direction, around the core, and a cover layer having no pore, surrounding the hollow tubular layer.

The attenuation of this fiber was measured and found to be 50 dB/km at 850 nm, and the bandwidth at 200 m was 10 GHz.

### Example 5

At the lower end of a PFA tube having an inner diameter of 33 mm, a stopper made of PFA, having holes formed so that plurality of rods having a diameter of 1 mm could be secured, was attached, and 30 aluminum tubes having an outer diameter of 1 mm were inserted thereto. And in an oven at 250° C., a molten fluororesin (PBVE-4M polymer) was introduced to the space in the tube. When left to stand under vacuum at 250° C. for 24 hours, no space was left between the resin and the aluminum tubes, whereupon the oven was cooled to room temperature. The aluminum tubes were pulled and removed to obtain a preform having a length of 20 cm and having 30 holes with a diameter of 1 mm formed. This preform was stretched at 240° C. by means of a drawing furnace to obtain a fiber having a diameter of 500 μm.

The cross section of the obtained fiber was analogous to the preform. The attenuation of this fiber was measured and found to be 50 dB/km at 850 nm, and the bandwidth at 200 m was 10 GHz.

### Example 6

A preform was prepared in the same manner as in Example 5 except that in Example 5, instead of aluminum tubes, glass tubes having an outer diameter of 1 mm were employed. It was impossible to pull out the glass tubes, and therefore, by immersion in a 25% hydrofluoric acid solution for 40 hours, glass tubes were completely dissolved. After washing with water thoroughly, the preform was dried in vacuum at 60° C. for three days, followed by stretching at 250° C. in the same manner as in Example 1 to obtain a fiber of 250 μm. The attenuation of this fiber was 45 dB/km at 850 nm, and the bandwidth was 12 GHz at 300 m.

### Example 7

Using the same apparatus as in Example 5, instead of introducing the molten resin at 250° C., perfluoro(3-oxa-1,6-heptadiene) (BE monomer), diisopropylperoxy dicarbonate (IPP) as a polymerization initiator and methanol as a chain transfer agent, were added, and polymerization was carried out at 50° C. for 24 hours, at 70° C. for 10 hours and at 110° C. for 10 hours. The solid formed by the polymerization was cooled to room temperature and then immersed in 20% hydrochloric acid for 24 hours, whereby the aluminum tubes were removed.

Certain irregularities were observed on the inner surfaces. Therefore, the preform was immersed in a perfluorosolvent (FC-77 solvent, tradename, manufactured by 3M) for 5 minutes, whereby irregularities on the inner surfaces disappeared. After vacuum drying, the preform was stretched to obtain an optical fiber having a diameter of 300 μm.

The attenuation of this fiber was 45 dB/km at 850 nm, and the bandwidth was 12 GHz at 300 m.

### Example 8

A polymer of PBVE-4M was melted and introduced into a PFA tube having a diameter of 33 mm and a length of 30 cm and then cooled to obtain a columnar rod having a diameter of 33 mm and a length of 20 cm. In this rod, except for the center, 50 through holes were formed by means of a long drill having a diameter of 1 mm. The inner surfaces were roughened by the drill. Therefore, the rod was immersed in the above perfluorosolvent for one minute and then withdrawn, whereby the inner surfaces of the holes were found to be smoothly etched.

This preform was dried under vacuum at 60° C. for 40 hours and then stretched to obtain an optical fiber having a diameter of 300 μm.

The attenuation of this fiber was 45 dB/km at 850 nm, and the bandwidth was 12 GHz at 300 m.

### INDUSTRIAL APPLICABILITY

In the present invention, at the time of producing a porous optical transmission article, an amorphous fluoropolymer having substantially no C—H bond, is used as the base material polymer, whereby it is possible to provide flexibility in the moldability and mechanical characteristics of the optical fiber as compared with a hard and brittle material such as SiO₂ and yet optical transmittance in a near infrared region is made possible, which can not be transmitted by a hydrocarbon type resin such as PMMA due to harmonic absorption of stretching vibration of the C—H bond. Especially when a fluoropolymer, particularly a polymer having a fluorinated alicyclic structure which may contain a cyclic member ether bond, is used, it is possible to obtain a plastic optical transmission article having a higher band region, whereby the material distribution is smaller than glass and acryl.

Further, the plastic optical transmission article of the present invention made of the above fluoropolymer, is not only safe and easy to handle without breakage or sticking, but also is excellent in e.g. transparency, heat resistance, moisture resistance, weather resistance, chemical resistance, non-flammability and flexibility, and it is suitable for applications to wirings in plants and wirings in sewerage systems where chemical resistance is required.

The entire disclosure of Japanese Patent Application No. 2002-242115 filed on Aug. 22, 2002 including specification, claims, drawings and summary is incorporated herein by reference in its entirety.

1. A porous plastic optical transmission article which is made of an amorphous fluoropolymer containing substantially no C—H bond and has a plurality of pores at least in a hollow tubular portion provided so as to surround the axial core portion of the optical transmission article.

2. The porous plastic optical transmission article according to claim 1, wherein the fluoropolymer contains a fluorinated cyclic structure.

3. The porous plastic optical transmission article according to claim 2, wherein the fluorinated cyclic structure is a fluorinated alicyclic structure which may contain a cyclic member ether bond.

4. The porous plastic optical transmission article according to claim 1, wherein the fluoropolymer has a fluorinated cyclic structure in its main chain.

5. The porous plastic optical transmission article according to claim 1, wherein the plurality of pores are present randomly over the entirety of the optical transmission article including the axial core portion.

6. The porous plastic optical transmission article according to claim 1, wherein the plurality of pores extend in parallel with the long axis direction of the optical transmission article made of the fluoropolymer and are periodically arranged including the axial core portion in the diametrical cross section of the optical transmission article, to form a photonic crystal structure.

7. The porous plastic optical transmission article according to claim 5, which has a solid-core structure wherein no pores are present at the axial core portion.

8. The porous plastic optical transmission article according to claim 6, wherein the axial core portion has a solid-core structure or a hollow structure, which ruptures the periodicity in arrangement of the pores, and the axial core portion constitutes a defect in the photonic crystal structure.

9. The porous plastic optical transmission article according to claim 8, wherein the photonic crystal structure develops a photonic band gap to the frequency of light wave-guided through the hollow or solid-core axial core portion.

10. A preform to be used for producing the porous plastic optical transmission article as defined in claim 1, which is made of an amorphous fluoropolymer containing substantially no C—H bond and contains at least a porous hollow tube having in the tube wall a plurality of pores extending in the long axis direction.

11. A method for producing the porous plastic optical transmission article as defined in claim 1 or its preform, which comprises molding by extrusion in contact with a gas an amorphous fluoropolymer containing substantially no C—H bond.

12. A method for producing the porous plastic optical transmission article as defined in claim 1 or its preform, which comprises removing from a product of coextrusion molding of an amorphous fluoropolymer containing substantially no C—H bond with another substance, said another substance, to obtain a molded product having a plurality of pores extending in the long axis direction.

13. A method for producing a preform for the porous plastic optical transmission article as defined in claim 1, which comprises letting a gaseous or volatile low molecular weight blowing agent act on a hollow tube molded from an amorphous fluoropolymer containing substantially no C—H bond, or foaming and molding a fluoropolymer having the blowing agent preliminarily incorporated, into a hollow tube, to obtain a porous hollow preform having a plurality of pores in the tube wall.

14. A method for producing a preform as defined in claim 10, which comprises melting an amorphous fluoropolymer containing substantially no C—H bond and introducing it into an inside space of a tubular container wherein a plurality of slender components are arranged in parallel with one another, and solidifying it, or introducing a liquid containing at least a monomer for the fluoropolymer into said inside space and polymerizing and solidifying it, to obtain a tubular rod, and removing said slender components from the obtained tubular rod.

15. A method for producing a perform as defined in claim 10, which comprises mechanically forming holes in a tubular solid-core rod made of an amorphous fluoropolymer containing substantially no C—H bond.

16. A method for producing a perform as defined in claim 10, which comprises bundling a plurality of capilli made of an amorphous fluoropolymer containing substantially no C—H bond, and fusing and integrating them as bundled.

17. A method for producing the porous plastic optical transmission article as defined in claim 1, which comprises melt spinning the preform as defined in claim 10 in the long axis direction.

18. A method for producing the porous plastic optical transmission article having a solid-core structure as defined in claim 1, wherein the preform as defined in claim 10 has a hollow tubular structure, and while inserting a solid-core rod made of the fluoropolymer into the hollow portion of the preform or after inserting the solid-core rod into the porous hollow preform, melt spinning is carried out in the long axis direction.

19. The porous plastic optical transmission article according to claim 1, which further has one or more coating layers containing no pores, on the periphery of the hollow tubular layer having a plurality of pores.

20. The porous plastic optical transmission article according to claim 1, wherein the optical transmission article is an optical fiber.

21. A bundled fiber having at least two optical fibers as defined in claim 20 bundled.

22. A multi-core cable having at least two optical fibers as defined in claim 20 accommodated in one cable.
